(19) United States
(12) Patent Application Publication
(10) Pub. No.: US 2007/0187047 A1
(43) Pub. Date: Aug. 16, 2007

(54) Decorative wall covering assembly

(76) Inventor: Elizabeth Ingrassia, Garden City, NY (US)

Correspondence Address: HOLLAND & KNIGHT LLP, 10 ST. JAMES AVENUE, 11th Floor, BOSTON, MA, 02116-3889, US

(21) Appl. No.: 11/354,409

(22) Filed: Feb. 15, 2006

(51) Int. Cl. E06B 9/26

(52) U.S. Cl. 160/166.1; 160/10

(57) ABSTRACT

A blind assembly includes a retractable shading device including a plurality of slats forming an inner surface and an outer surface. The blind assembly is configured to be positioned proximate a wall opening. A retraction assembly is configured to allow for the retraction of the retractable shading device with respect to the wall opening. At least one image is repeatedly applied to at least one surface of the retractable shading device.

### TECHNICAL FIELD

This disclosure relates to shading assemblies and, more particularly, to shading assemblies including imagery.

### BACKGROUND

Shading assemblies are often used to shade window and door openings. Examples of such shading assemblies include blind assemblies (e.g., horizontal blind assemblies and vertical blind assemblies) and shade assemblies (e.g., Roman shade assemblies, rollup shade assemblies, and pleated shade assemblies). Blinds and shades may be used on window openings to provide privacy and to regulate the amount of outdoor light passing through the window. Blinds and shades may also be used on various types of doorways (e.g., sliding glass doors) to achieve similar results.

Unfortunately, these shading assemblies tend to be nondescript and functional. Often, shades and blinds are a single color and may do little to enhance the artistic and visual appeal of a room.

### SUMMARY OF DISCLOSURE

In one implementation, a blind assembly includes a retractable shading device including a plurality of slats forming an inner surface and an outer surface. The blind assembly is configured to be positioned proximate a wall opening. A retraction assembly is configured to allow for the retraction of the retractable shading device with respect to the wall opening. At least one image is repeatedly applied to at least one surface of the retractable shading device.

One or more of the following features may also be included. The wall opening may be a window opening and the retractable shading device may be a window shading device. The wall opening may be a doorway and the retractable shading device may be a door shading device.

The retractable shading device may be constructed of a material chosen from the group consisting of: a fabric material, a plastic material, and a wooden material. The plurality of slats may include one or more vertical slats. The plurality of slats may include one or more horizontal slats.

The blind assembly may include an angle adjustment assembly for varying the angular orientation of one or more of the plurality of slats. The retraction assembly may include a drawstring assembly for retracting the blind assembly. The retraction assembly may include a wand/rod assembly for retracting the blind assembly. The image may include: a cartoon image; a photographic image; a lithographic image; a sports logo; a corporate logo; an advertisement; a charcoal-sketch image; a hand-painted image; a silk-screened image; a pastel image; and/or a holographic image.

The details of one or more implementations are set forth in the accompanying drawings and the description below. Other features and advantages will become apparent from the description, the drawings, and the claims.

### BRIEF DESCRIPTION OF DRAWINGS

FIG. 1 is a diagrammatic view of a decorative wall covering assembly;

FIG. 2 is a side diagrammatic view of the decorative wall covering assembly of FIG. 1;

FIG. 3 is an alternative diagrammatic view of the decorative wall covering assembly of FIG. 1;

FIG. 4 is an alternative diagrammatic view of the decorative wall covering assembly of FIG. 1;

FIG. 5 is another embodiment of the decorative wall covering assembly of FIG. 1;

FIG. 6 is another embodiment of the decorative wall covering assembly of FIG. 1;

FIG. 7 is another embodiment of the decorative wall covering assembly of FIG. 1;

FIG. 8 is another embodiment of the decorative wall covering assembly of FIG. 1;

FIG. 9 is a side diagrammatic view of the decorative wall covering assembly of FIG. 8;

FIG. 10 is a side diagrammatic view of another embodiment of the decorative wall covering assembly of FIG. 8; and

FIG. 11 is another embodiment of the decorative wall covering assembly of FIG. 1.

### DETAILED DESCRIPTION OF THE DISCLOSURE

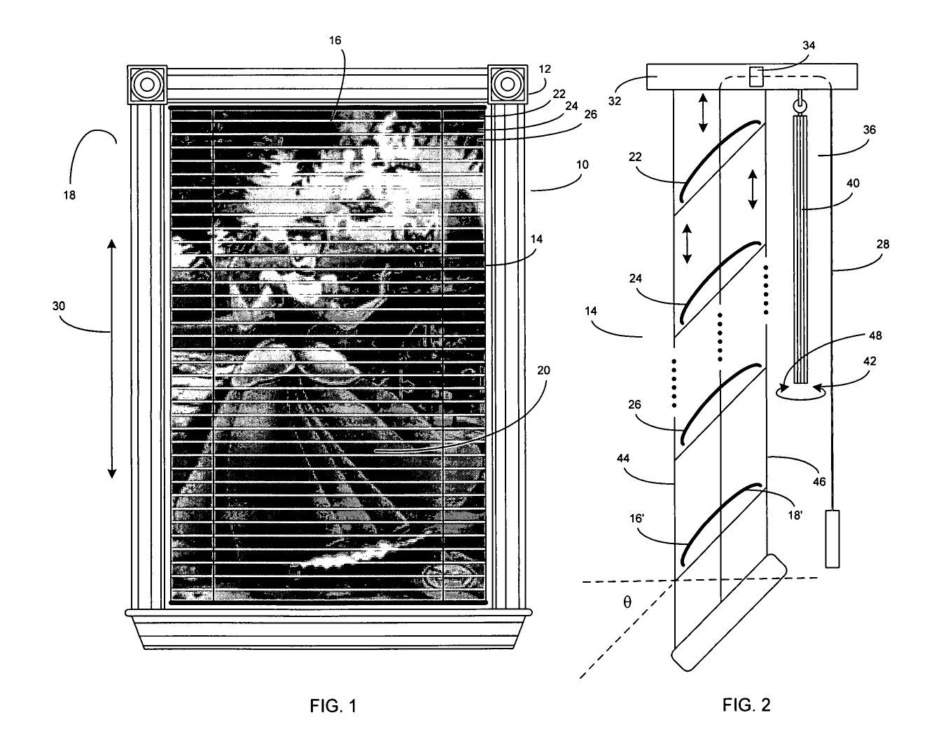

Referring to FIGS. 1 & 2, there is shown a decorative wall covering assembly 10 fitted within a window opening 12. Decorative wall covering assembly 10 may be installed within window openings (as shown in FIG. 1) or door openings (to be discussed below). Examples of decorative wall covering assembly 10 include shades (e.g., cellular shades, honeycomb shades, pleated shades, Roman shades, solar screens, sheer shades, and woven shades, for example) and blinds (e.g., vertical blinds and horizontal blinds, for example). Depending on configuration and personal preference, shades and blinds may be constructed of a fabric material (e.g., a cotton blended fabric), a plastic material (e.g., vinyl), and/or a wooden material (e.g., cherry wood).

Decorative wall covering assembly 10 may include a retractable shading device 14 that obscures the passage of light through window opening 12, thus allowing the user (not shown) to e.g., regulate the amount of light within a room or regulate the privacy level within the room. Retractable shading device 14 may include a first (i.e., inward facing) surface and a second (i.e., outward facing) surface. In this particular example, the first surface 16 of retractable shading device 14 is illustrated, while the second surface 18 of retractable shading device 14 faces the window (and is therefore obscured).

One or more of the surfaces (i.e., first surface 16 and/or second surface 18) of retractable shading device 14 may have an image applied to it. In this particular example, an image 20 of Disney's™ Cinderella™ is applied to first surface 16 of retractable shading device 14.

While image 20 is showed being applied to the first surface 16 of retractable shading device 14, this is for illustrative purposes only and other configurations are considered to be within the scope of this disclosure. For example, image 20 may be applied to the second surface 18 of retractable shading device 14.

While image 20 is showed being applied to only one surface (i.e., first surface 16) of retractable shading device 14, this is for illustrative purposes only and other configurations are considered to be within the scope of this disclosure. For example, image 20 may be applied to both the first surface 16 and the second surface 18 of retractable shading device 14.

Depending on the configuration of decorative wall covering assembly 10, retractable shading device 14 may include a plurality of slats (e.g., slats 22, 24, 26), each of which has a first surface (e.g., slat surface 16′) and a second surface (e.g., slat surface 18′). Accordingly, when retractable shading device 14 includes a plurality of slats, the individual surfaces of the slats (i.e., slat surfaces 16′ and/or 18′) when combined with the slat surfaces of adjacent slats (e.g., slat 26) form the first surface 16 and/or second surface 18 of retractable shading device 14. Therefore, if an image (e.g., image 20) is applied to the first surface 16 and/or second surface 18 of a retractable shading device 14 (that includes a plurality of slats), only a portion of the image will be applied to each surface of each slat (as shown in FIG. 1).

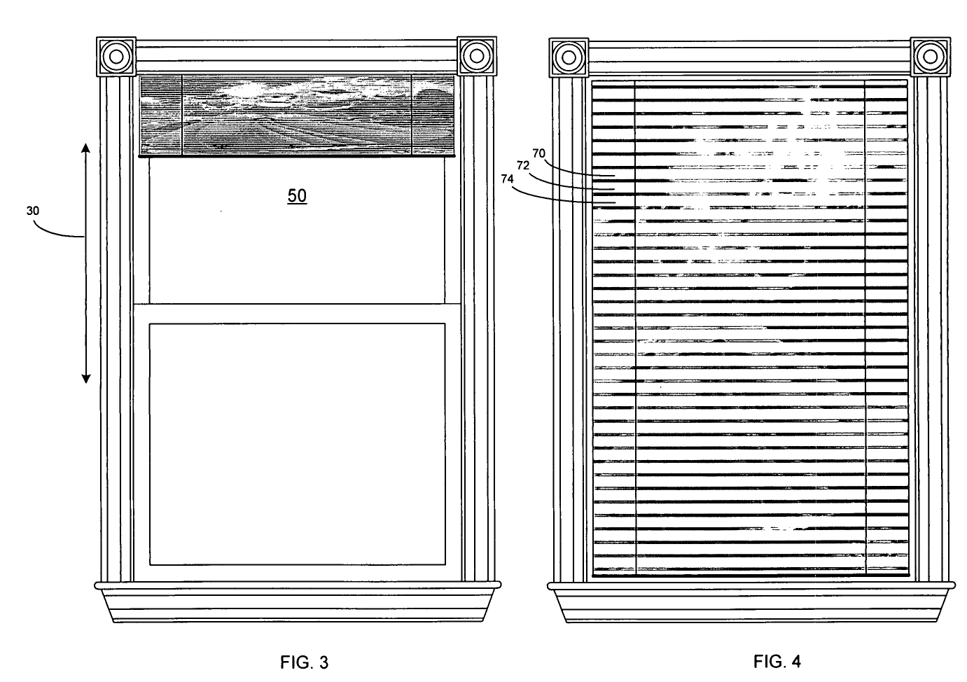

Decorative wall covering assembly 10 may include a retraction assembly 28 that is configured to allow for the retraction of retractable shading device 14. Specifically, in the embodiment disclosed in FIGS. 1 & 2, retraction assembly 28 allows for the vertical (i.e., up & down) displacement of retractable shading device 14 along Y-axis 30. If retractable shading device 14 includes a plurality of slats, examples of retraction assembly 28 includes a drawstring (as shown in FIG. 2) that may extend through upper support 32 of decorative wall covering 10 and downward through the slats. Accordingly and referring also to FIG. 3, when (in this example) retraction assembly 28 is pulled downward, the individual slats (e.g., slats 22, 24, 26) of retractable shading device 14 are displaced upward (resulting in retractable shading device 14 being reduced in size along Y-axis 30 and allowing for the passage of light through window 50. Retraction assembly 28 may include a locking assembly 34 for releasably grasping retraction assembly 28 and e.g., maintaining retractable shading device 14 in an open position (as shown in FIG. 3).

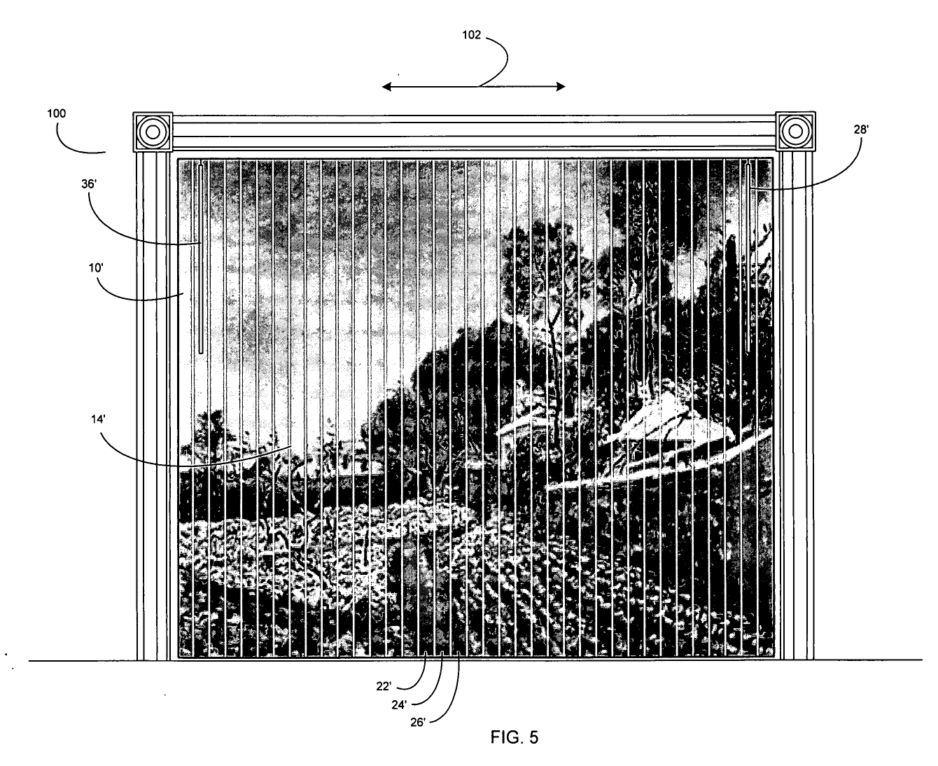

If retractable shading device 14 includes slats, decorative wall covering assembly 10 may include an angle adjustment assembly 36 for varying the angle θ between a slat and (in this particular embodiment) the horizon. Angle adjustment assembly 36 may be implemented in various fashions, such as a rotating rod 40. Specifically, angle adjustment assembly 36 may be configured so that when rotating rod 40 is rotated in a first direction (e.g., in the direction of arrowhead 42), cable 44 moves upward and cable 46 moves downward, resulting in the individual slats (e.g., slats 24, 26, 28) moving toward the horizontal position and angle θ being reduced. Conversely, angle adjustment assembly 36 may be configured so that when rotating rod 40 is rotated in a second direction (e.g., in the direction of arrowhead 48), cable 44 moves downward and cable 46 moves upward, resulting in the individual slats (e.g., slats 24, 26, 28) moving toward the vertical position and angle θ being increased. When the slats are horizontal (as shown in FIG. 4), the spaces 70, 72, 74 between the slats is maximized, thus allowing more light to pass into the room. Conversely, when the slats are vertical (as shown in FIG. 1), the spacing between the slats is minimized, thus providing a higher level of privacy.

Referring also to FIG. 5, while decorative wall covering assembly 10 is described above as being positioned within (i.e., proximate) a window opening, other configurations are possible and are considered to be within the scope of this disclosure. For example, decorative wall covering assembly 10′ may be positioned within a doorway 100. Additionally, while retractable shading device 14 is described above as being retractable along the Y-axis (i.e., up & down), other configurations are possible and are considered to be within the scope of this disclosure. For example, retractable shading device 14′ may be retractable along the X-axis (i.e., left & right) 102, thus allowing for the retraction of retractable shading device 14′ to gain access to the door within doorway 100. While retraction device 28 (FIG. 2) is shown to include a drawstring for allowing for the vertical (i.e., up & down) displacement of retractable shading device 14 (FIG. 2) along Y-axis 30 (FIG. 1), a wand/rod assembly 28′ may be included to allow for the horizontal (i.e., left & right) displacement of retractable shading device 14′ along X-axis 102. Further, while retractable shading device 14 is described above as including a plurality of horizontal slats 22, 24, 26, other configurations are possible and are considered to be within the scope of this disclosure. For example, vertical slats 22′, 24′, 26′ may be included within retractable sliding device 14′. Angle adjustment assembly 36′ may be included to allow for axial rotation of vertical slats 22′, 24′, 26′.

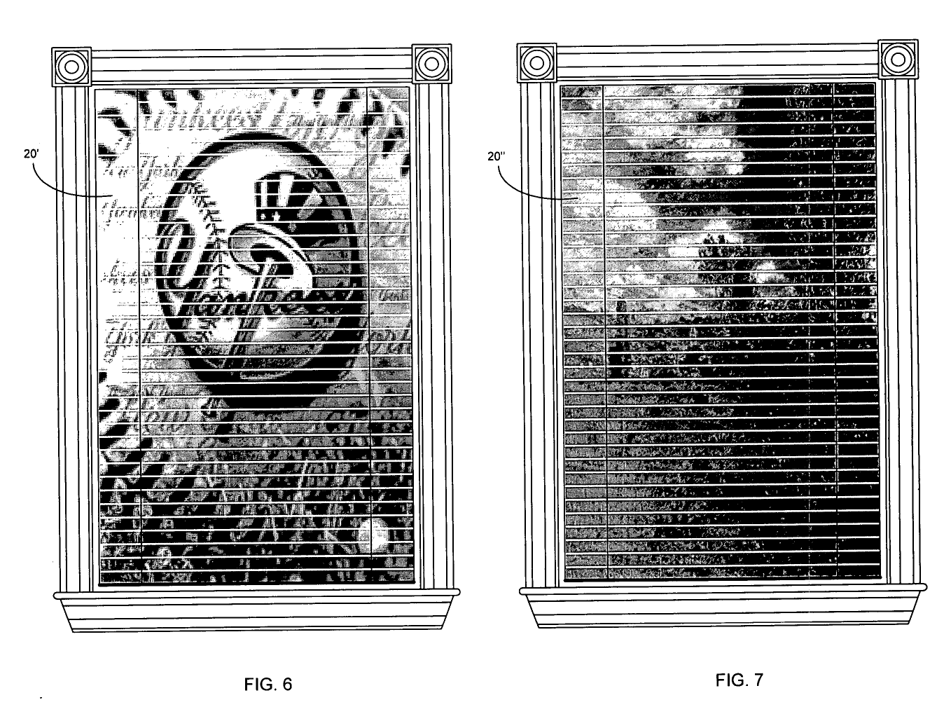

While the decorative wall covering assembly is described above as including a cartoon image 20 (i.e., Disney's™ Cinderella™), other configurations are possible and are considered to be within the scope of this disclosure. For example, image 20′ may include a sports logo (the New York Yankees™ logo, as shown in FIG. 6) and/or image 20″ may include a lithograph of a famous piece of artwork (i.e., The Ile Saint-Martin, Vetheuil by Monet, as shown in FIG. 7). Additionally/alternatively, image 20 may include: a corporate logo (e.g., the Budweiser™ logo, not shown), a photographic image (e.g., a photograph a person's grandchild, not shown), and/or an advertisement (e.g., a Nynex™ advertisement, not shown).

Image 20 is not intended to be limited to any particular type of artwork. For example, while one embodiment of image 20 is described above as including a lithograph, other configurations/embodiments are possible. For example, image 20 may include a charcoal-sketch image, a hand-painted image, a silk-screened image, a pastel image, and/or a holographic image.

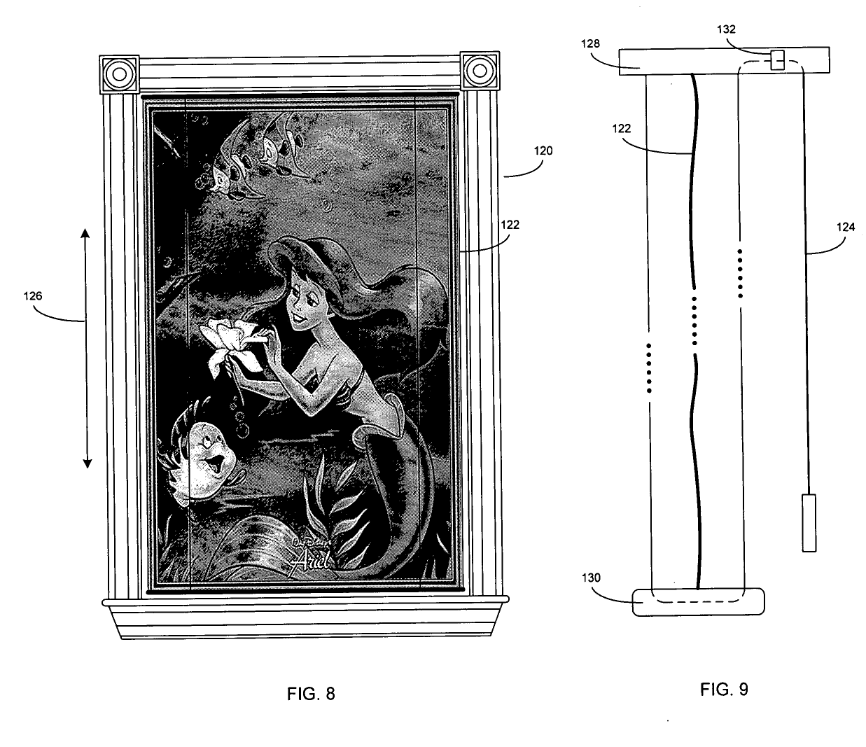

While the decorative wall covering assembly is described above as including a plurality of slats (either vertical or horizontal), other configurations are possible and are considered to be within the scope of this disclosure. For example and referring also to FIGS. 8 & 9, decorative wall covering assembly 120 may include a one-piece retractable shading device 122. One-piece retractable shading device 122 may be constructed of a plastic material (e.g., vinyl), a wooden material (e.g., bamboo), and/or a fabric material (e.g., a woven cotton blend).

Decorative wall covering assembly 120 may include a retraction assembly 124 that is configured to allow for the retraction of retractable shading device 122. Specifically, in the embodiment disclosed in FIGS. 8 & 9, retraction assembly 124 allows for the vertical (i.e., up & down) displacement of retractable shading device 122 along Y-axis 126. Retraction assembly 124 may include a drawstring that may extend through upper support 128 of decorative wall covering 120 and downward behind one-piece retractable shading device 122 through lower support 130 and then upward and rigidly attached to upper support 128. Accordingly, when (in this example) retraction assembly 124 is pulled downward, lower support 130 is raised toward upper support 128 (resulting in retractable shading device 122 being reduced in size along Y-axis 126 and allowing for the passage of light through the window to which decorative wall covering 120 is attached. Retraction assembly 124 may include a locking assembly 132 for releasably grasping retraction assembly 124 and e.g., maintaining retractable shading device 122 in an open position.

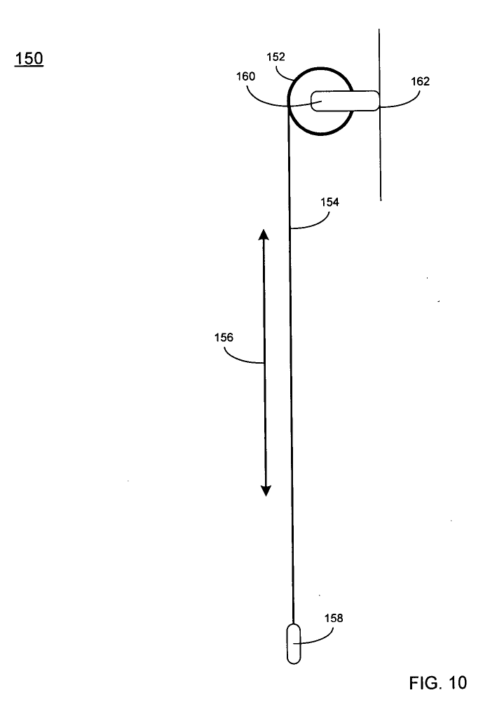

While the decorative wall covering assembly is described above as having a “drawstring-type” retraction assembly, other configurations are possible and are considered to be within the scope of this disclosure. For example and referring also to FIG. 10, decorative wall covering 150 may include a roller assembly 152 for retracting retractable shading device 154, thus allowing retractable shading device 154 to move along the Y-axis 156. Decorative wall covering 150 may include a weight assembly 158 for holding retractable shading device 154 taught. One or more bracket assemblies 160 may affix roller assembly 152 to wall 162.

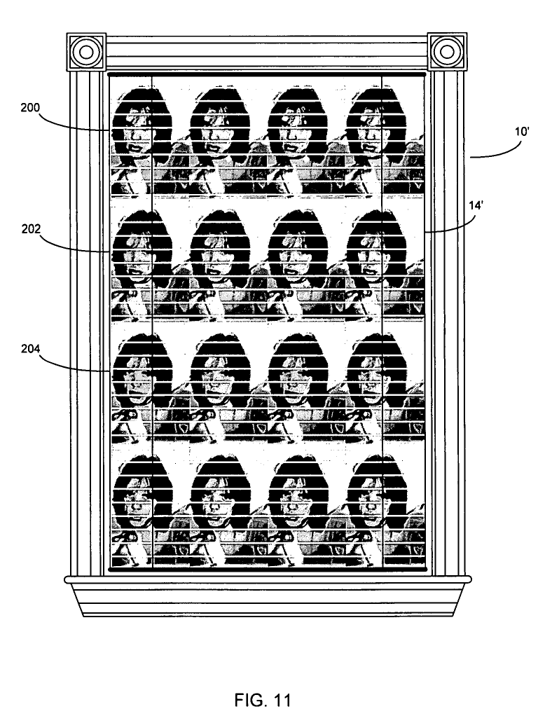

While the embodiments of the decorative wall covering assembly are described above as including a single occurrence of a single image, other configurations are possible and are considered to be within the scope of this disclosure. For example and referring also to FIG. 11, an alternative embodiment of decorative wall covering assembly 10′ may include a retractable shading device 14′ including multiple occurrences of a single image (e.g., images 200, 202, 204) to form a repetitive pattern on retractable shading device 14′. Additionally/alternatively, multiple occurrences of distinct images may be included on retractable shading device 14′ to form a mosaic (not shown). Additionally/alternatively, individual patterns (e.g., paisley patterns, Fleur-de-Lys patterns, cartoon images, star images, rainbow images, lithographic images, screen-printed images, charcoal-sketch images, hand-painted images, pastel images and/or a holographic images, for example) may be included within retractable shading device 14′ to form a repetitive pattern and/or a mosaic pattern.

A number of implementations have been described. Nevertheless, it will be understood that various modifications may be made. Accordingly, other implementations are within the scope of the following claims.

What is claimed is:

1. A blind assembly comprising:
a retractable shading device including a plurality of slats forming an inner surface and an outer surface and configured to be positioned proximate a wall opening;
a retraction assembly configured to allow for the retraction of the retractable shading device with respect to the wall opening; and
at least one image repeatedly applied to at least one surface of the retractable shading device.

2. The blind assembly of claim 1 wherein the wall opening is a window opening and the retractable shading device is a window shading device.

3. The blind assembly of claim 1 wherein the wall opening is a doorway and the retractable shading device is a door shading device.

4. The blind assembly of claim 1 wherein the retractable shading device is constructed of a material chosen from the group consisting of: a fabric material, a plastic material, and a wooden material.

5. The blind assembly of claim 1 wherein the plurality of slats includes one or more vertical slats.

6. The blind assembly of claim 1 wherein the plurality of slats includes one or more horizontal slats.

7. The blind assembly of claim 1 further comprising an angle adjustment assembly for varying the angular orientation of one or more of the plurality of slats.

8. The blind assembly of claim 1 wherein the retraction assembly includes a drawstring assembly for retracting the blind assembly.

9. The blind assembly of claim 1 wherein the retraction assembly includes a wand/ rod assembly for retracting the blind assembly.

10. The blind assembly of claim 1 wherein the image includes a cartoon image.

11. The blind assembly of claim 1 wherein the image includes a photographic image.

12. The blind assembly of claim 1 wherein the image includes a lithographic image.

13. The blind assembly of claim 1 wherein the image includes a sports logo.

14. The blind assembly of claim 1 wherein the image includes a corporate logo.

15. The blind assembly of claim 1 wherein the image includes an advertisement.

16. The blind assembly of claim 1 wherein the image includes a charcoal-sketch image.

17. The blind assembly of claim 1 wherein the image includes a hand-painted image.

18. The blind assembly of claim 1 wherein the image includes a silk-screened image.

19. The blind assembly of claim 1 wherein the image includes a pastel image.

20. The blind assembly of claim 1 wherein the image includes a holographic image.
